(19) United States
(12) Patent Application Publication
(10) Pub. No.: US 2023/0300253 A1
(43) Pub. Date: Sep. 21, 2023

(54) ROUTING HIGH PRIORITY, LOW LATENCY EMERGENCY CALLS USING LLD SF

(71) Applicant: ARRIS Enterprises LLC, Suwanee, GA (US)

(72) Inventors: Sabarinathan NAGARAJAN, Bangalore (IN); Kokila Harikrishina, Bangalore (IN)

(21) Appl. No.: 18/122,244

(22) Filed: Mar. 16, 2023

Related U.S. Application Data
(60) Provisional application No. 63/321,823, filed on Mar. 21, 2022.

(51) Int. Cl. H04M 7/00

(52) U.S. Cl. CPC H04M 7/0024; H04M 7/006; H04M 2242/04

(57) ABSTRACT

An access point device can receive one or more emergency call packets from a client device. These one or more emergency call packets are identified as associated with an emergency call, for example, based on one or more identifiers. The one or more emergency call packets are sent high priority, low latency based on an embedded multimedia terminal adapter sending an emergency call notification to a cable modem which performs a dynamic service change (DSC) update to one or more classifier rules so that these packets are routed via a low latency DOCSIS service flow to a cable modem termination system (CMTS). In this way, the one or more emergency call packets received from the client device and any one or more response emergency call packets received from a network device (the intended recipient or target of the emergency call) are routed via an LLD service flow.

### BACKGROUND

The low latency data over cable service interface specification (DOCSIS) aims at achieving about a one millisecond round-trip delay for time sensitive data packets, for example, data packets associated with online gaming applications. Generally, a cable modem with an embedded multimedia terminal adapter (eMTA) can be utilized for online gaming applications to provide a low latency DOCSIS (LLD) service flow, such a cable modem can also be used for providing telephony calls. Typically, classifier rules are added in the configuration file of the cable modem so as to route the signaling messages associated with the telephony calls vi a preconfigured service flow where a service is dynamically created to handle the telephony call. For an emergency call, when a user dials an emergency number such as 911, the same procedure is followed except at the eMTA preference is given to the emergency call, for example, the emergency call is allowed even during a low battery environment, elevated in priority so as to not be put on hold, routed even when a call server is not available, etc. However, at the DOCSIS level, the emergency call does not receive any differentiation in treatment. Thus, there is a need to elevate an emergency call at the DOCSIS level so as to route the emergency call with a high priority, low latency using a LLD service flow.

### SUMMARY

According to aspects of the present invention, an improved treatment for emergency calls by elevating the emergency call to the highest priority and routing the emergency call packets via a LLD service flow. As LLD addresses queuing delay and media acquisition delay by creating the LLD service flow of an aggregate service flow (ASF), when a user dials an emergency number, such as 911, instead of routing the call signaling traffic via the service flow defined by one or more classifier rules in a configuration file of the cable modem, the eMTA can send a notification to the cable modem to include the emergency call data packets in the LLD service flow so as to provide high priority, low latency handling of the emergency call. Subsequently, voice packets can also be routed via the same LLD service flow (as these voice packets will not be queue building unlike video packets) instead of creating a service flow dynamically as the service flow parameters may not match with the LLD service flow parameters.

An aspect of the present disclosure is drawn to an access point device for routing one or more emergency call packets associated with an emergency call. The access point comprises an embedded multimedia terminal adapter (eMTA), a cable modem coupled to the eMTA, a memory storing one or more computer-readable instructions, and a processor coupled to the memory. The processor is configured to execute the one or more computer-readable instructions to cause the access point device to receive at the eMTA the one or more emergency call packets associated with the emergency call, send from the eMTA an emergency call notification to the cable modem, perform, by the cable modem, a dynamic service change (DSC) to update one or more classifier rules to classify the one or more emergency call packets to be directed to a low latency data over cable service interface specification (LLD) service flow, and route the one or more emergency call packets via the LLD service flow based on the one or more classifier rules.

In an aspect of the present disclosure, the one or more emergency call packets are sent using real-time protocol (RTP) via the LLD service flow.

In an aspect of the present disclosure, the processor is further configured to execute the one or more computer-readable instructions to further cause the access point device to disable a queue protection function.

In an aspect of the present disclosure, at least one of the one or more emergency call packets comprise one or more emergency call identifiers.

In an aspect of the present disclosure, the processor is further configured to execute the one or more computer-readable instructions to further cause the access point device to identify the one or more emergency call packets as associated with an emergency call based on the one or more emergency call identifiers and wherein routing the one or more emergency call packets is based on the identifying.

In an aspect of the present disclosure, the processor is further configured to execute the one or more computer-readable instructions to further cause the access point device to receive one or more response emergency call packets via the LLD service flow.

In an aspect of the present disclosure, the one or more classifier rules are stored in the memory.

An aspect of the present disclosure is drawn to a method by an access point device for routing one or more emergency call packets associated with an emergency call. The method comprises receiving at an eMTA of the access point device the one or more emergency call packets associated with the emergency call, sending from the eMTA an emergency call notification to a cable modem of the access point device, performing, by the cable modem, a DSC to update one or more classifier rules to classify the one or more emergency call packets to be directed to a LLD service flow, and routing the one or more emergency call packets via the LLD service flow based on the one or more classifier rules.

In an aspect of the present disclosure, the method is such that the one or more emergency call packets are sent using RTP via the LLD service flow.

In an aspect of the present disclosure, the method further comprises disabling a queue protection function.

In an aspect of the present disclosure, the method is such at least one of the one or more emergency call packets comprise one or more emergency call identifiers.

In an aspect of the present disclosure, the method further comprising identifying the one or more emergency call packets as associated with an emergency call based on the one or more emergency call identifiers, and wherein routing the one or more emergency call packets is based on the identifying.

In an aspect of the present disclosure, the method further comprising receiving one or more response emergency call packets via the LLD service flow.

In an aspect of the present disclosure, the method is such that the one or more classifier rules are stored in the memory

An aspect of the present disclosure provides a computer readable medium of an access point device having one or more computer-readable instructions stored thereon. The one or more computer-readable instructions when executed by a processor of the access point device, cause the access point device to perform one or more operations including the steps of the methods described herein.

### BRIEF DESCRIPTION OF THE DRAWINGS

FIG. 1 is a diagram of a network environment for handling an emergency call, according to one or more aspects of the present disclosure;

FIG. 2 is a block diagram of a hardware configuration for one or more devices, according to one or more aspects of the present disclosure;

FIG. 3 is a flow diagram for routing an emergency call via an LLD service flow in a network environment, according to one or more aspects of the present disclosure; and

FIG. 4 is a flowchart for a method of routing an emergency call via an LLD service flow, according to one or more aspects of the present disclosure.

Like reference numbers and designations in the various drawings indicate like elements.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

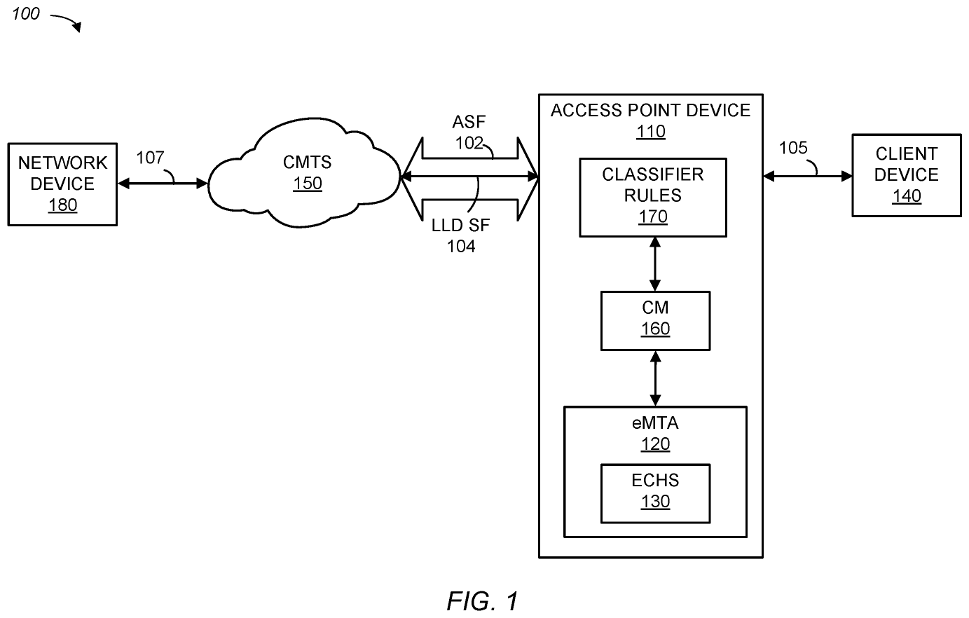

FIG. 1 is a diagram of an network environment 100 for handling an emergency call, according to one or more aspects of the present disclosure. The network environment 100 comprises one or more devices so as to form a network, such as any of one or more client devices 140, an access point device 110, a cable modem termination system (CMTS) 150, and a network device 180. While FIG. 1 illustrates various devices, the present disclosure contemplates any number of devices within the access network environment 100.

In one or more embodiments, a client device 140 can be any type of a device that connects to an access point device 110 and is capable of or configured to initiate an emergency call, for example, any of a hand-held computing device, a personal computer (such as a desktop, laptop, etc.), an electronic tablet, a mobile phone, a smart phone, an Internet-of-Things (IoT) device (such as smart assistant, iControl devices, portable music players with smart capabilities capable of connecting to the Internet, cellular networks, and interconnecting with other devices via Wi-Fi and Bluetooth (BT)), any other wireless electronic device, or any combination thereof. A client device 140 can be connected to an access point device 110 via a connection 105.

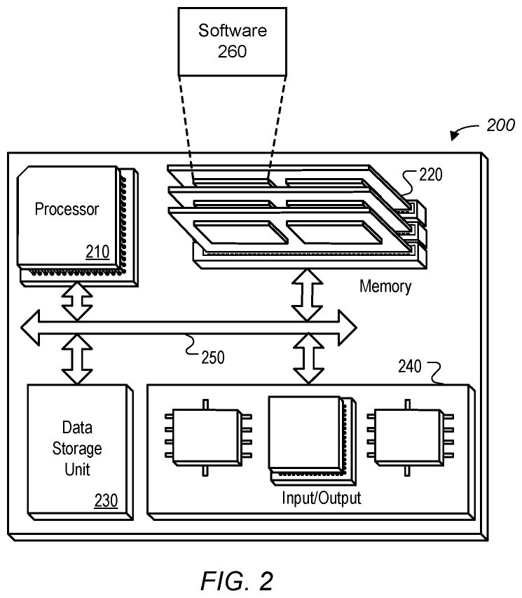

The access point device 110 can be an electronic device that supports LLD. For example, the access point device 110 can be configured to support routing one or more packets via a LLD service flow 104 of an ASF 102. The access point device 110 can comprise an access point and/or a hardware electronic device that can be a combination modem and gateway that combines the functions of a modem (for example, a cable modem 160), an access point (AP), and/or a router for providing content, data or information received from one or more client devices 140 to a CMTS 150. An access point device 110 can be referred to as a residential gateway, a home network gateway, or a wireless access point. The access point device 110 can comprise a cable modem 160, an eMTA 120, and one or more classifier rules 170 (for example, one or more classifier rules stored in a memory 200 as discussed with reference to FIG. 2).

A CMTS 150 can be communicatively coupled to the access point device 110 via an ASF 102 that comprises an LLD SF 104. For example, the access point device 110 can route one or more packets designated as emergency call packets by an emergency call handling service (ECHS) 130 of the eMTA 120 via a LLD service flow (SF) 104 of an ASF 102 to the CMTS 150. The CMTS 150 can, for example, be located at a head end of a multiple system operator (MSO). The CMTS 150 can utilize DOCSIS for communication of data packets, traffic, and/or information by one or more devices of the network environment 100. The CMTS 150 can connect the access point device 110 to a network device 180 via a connection 107 between the CMTS 150 and a network device 180.

Network device 180 can be any type of device that allows or supports communications with a client device 140. For example, the network device 180 can receive from a CMTS 150 (directly or indirectly) one or more packets, such as one or more telephony packets (also referred to as one or more emergency call packets) associated with an emergency call initiated by client device 140 to the network device 180 as the target of the emergency call (for example, the intended recipient). The network device 180 can send to the CMTS 150 one or more response emergency call packets for communication or routing to the client device 140.

FIG. 2 is a block diagram of a hardware configuration 200 for one or more devices within a network environment 100, for example, a client device 140. The hardware configuration 200 can comprise a processor 210, a memory 220, a storage device or data storage unit 230, and an input/output (I/O) device 240. Each of the components 210, 220, 230, and 240 can, for example, be interconnected using a system bus 250. The processor 210 can be capable of processing one or more computer-readable instructions for execution within the hardware configuration 200. In one or more embodiments, the processor 210 can be a single-threaded processor. In one or more embodiments, the processor 210 can be a multi-threaded processor. The processor 210 can be capable of processing one or more computer-readable instructions stored in the memory 220 and/or on the data storage unit or storage device 230. In one or more embodiments, one or more classifier rules 170 are stored in the data storage unit 230.

The memory 220 can store information within the hardware configuration 200, such as one or more classifier rules 170 and/or software 260. In one implementation, the memory 220 can be a computer-readable medium that stores one or more computer-readable instructions that when executed by a processor 210 cause the device to perform one or more operations according to one or more aspects of the present disclosure. In one implementation, the memory 220 can be a volatile memory unit. In another implementation, the memory 220 can be a non-volatile memory unit. In one or more embodiments, the storage device 230 can be capable of providing mass storage for the hardware configuration 200. In one implementation, the data storage unit 230 can be a computer-readable medium. In various different implementations, the data storage unit 230 can, for example, include a hard disk device, an optical disk device, flash memory or some other large capacity storage device. In other implementations, the data storage unit 230 can be a device external to the hardware configuration 200. Software 260 can comprise ECHS 130.

The I/O device 240 provides I/O operations for the hardware configuration 200. In one implementation, the I/O device 240 can include one or more of a network interface device (for example, an Ethernet card), a serial communication device (for example, an RS-232 port), one or more universal serial bus (USB) interfaces (for example, a USB 2.0 port), one or more wireless interface devices (for example, an 802.11 card) for outputting video, voice, and/or data services to a client device 140 of FIG. 1 (for example, television, STB, computer, mobile device, tablet, telephone, wearable, etc.). As an example, the I/O device 240 can include one or more driver devices configured to send communications to, and receive communications from one or more networks and/or one or more network devices, such as a remote node 102.

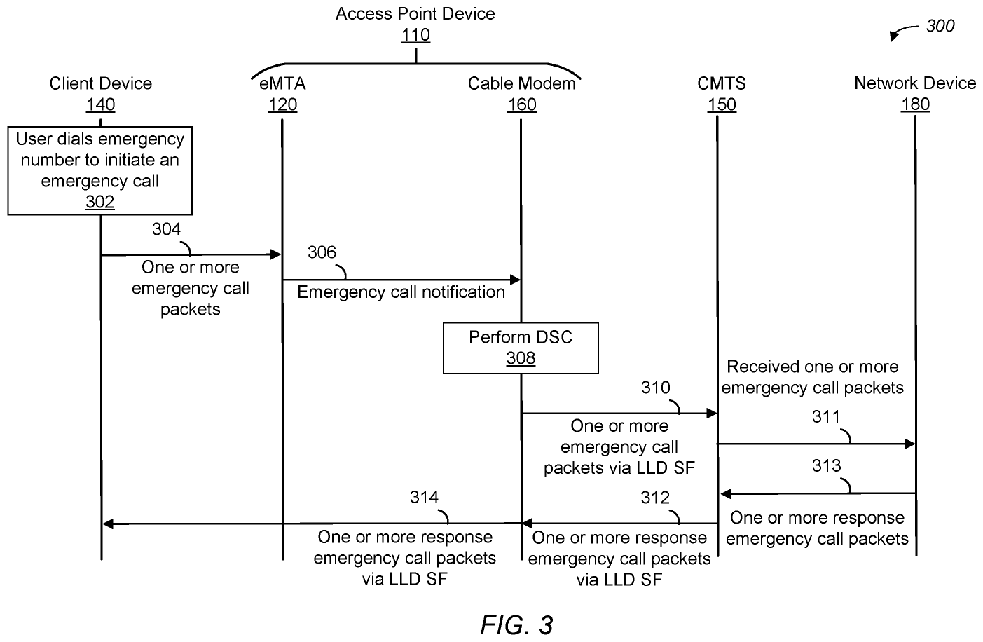

FIG. 3 is a flow diagram for routing an emergency call via an LLD service flow in a network environment 300, according to one or more aspects of the present disclosure. The network environment 300 can be the same as or similar to the network environment 100 of FIG. 1. In typical environments, telephony calls are handled by creating a different service flow for signaling messages and dynamic service flow creation for the real-time protocol (RTP) traffic but there is no differentiation made with respect to handling of an emergency call at the DOC SIS layer. According to one or more aspects of the present disclosure, an emergency call can be provided a high priority, low latency routing via a LLD service flow of an ASF so as to provide an enhanced user experience.

A user of a client device 140 can dial an emergency number to make an emergency call 302, for example, a user can dial 911 or any other designated emergency telephone number so as to initiate an emergency call to a target, such as a network device 180. The client device 140 sends one or more emergency call packets 304 associated with the emergency call 302 to an eMTA 120 of an access point device 110. At least one of the one or more emergency call packets 304 can comprise one or more emergency call identifiers that indicate that the one or more emergency call packets 304 are associated with an emergency call 302. For example, ECHS 130 of the eMTA 120 can receive the one or more emergency call packets 304 and determine based on the one or more emergency call identifiers associated with the one or more emergency call packets 304 that the one or more emergency call packets 304 are associated with an emergency call 302 and thus should receive high priority, low latency treatment. The ECHS 130 can send an emergency call notification 306 based on the one or more emergency call packets 304 and/or the determination to the cable modem 160.

The cable modem 160 upon receiving the emergency call notification 306 can perform a dynamic service change (DSC) so as to update one or more classifier rules 170 so that the one or more emergency call packets 304 received from the client device 140 are classified to be directed to the LLD service flow in the downstream direction. Further, RTP traffic can also be sent and received via the LLD service flow to achieve the least possible latency as the emergency call and associated one or more emergency call packets 304 are of or otherwise designated as high priority. A queue protection function at the cable modem 160 can be disabled for the duration of the emergency call 302 so that one or more associated voice packets (the one or more emergency call packets 304) are not routed to a normal classic service flow.

The cable modem 160 routes the one or more emergency call packets 304 via an LLD service flow 104 of an ASF 102 as one or more emergency call packets 310 to the CMTS 150 based on the one or more classifier rules. The CMTS 150 sends the one or more emergency call packets 310 received via the LLD service flow 104 as one or more received emergency call packets 311 to a network device 180 associated with the one or more emergency call packets 310, such as the intended target of the emergency call 302. For example, the network device 180 can be a device at a call center for receiving, directing, and/or handling emergency calls. The network device 180 can send one or more response emergency call packets 313 to the CMTS 150. The CMTS 150 can then forward or otherwise route the one or more response emergency call packets via the LLD service flow 104 to the cable modem 160 which sends the one or more response emergency call packets to the client device 140.

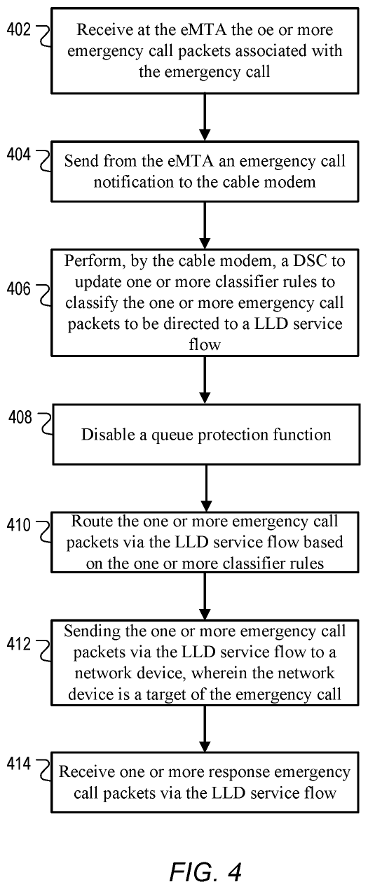

FIG. 4 is a flowchart for a method of routing an emergency call via an LLD service flow, according to one or more aspects of the present disclosure. In FIG. 4, it is assumed that any one or more devices include their respective controllers and/or processors and their respective software (such as one or more computer-readable instructions) stored in their respective memories, as discussed above in reference to FIGS. 1-3, which when executed by their respective controllers perform one or more functions or operations in accordance with the example embodiments of the present disclosure.

The processor 210 executes one or more computer-readable instructions, stored in a memory, for example, a memory 220 of an access point device 110, that when executed by the processor 210 perform and/or cause the access point device 110 to perform one or more of the operations of steps 402-S414. In one or more embodiments, the one or more computer-readable instructions may be one or more software applications. While the steps 402-414 are presented in a certain order, the present disclosure contemplates that any one or more steps can be performed simultaneously, substantially simultaneously, repeatedly, in any order or not at all (omitted).

At step 402, the access point device 110 receives at the eMTA 120 one or more emergency call packets associated with an emergency call from a client device 140. The emergency call can comprise one or more emergency call identifiers. The one or more emergency call identifiers can indicate or otherwise identify the emergency call as a high priority, low latency call, a target of the emergency call, or both.

At step 404, the access point device 110 sends from the eMTA 120 an emergency call notification to the cable modem 160. The notification causes the cable modem 160 at step 406 to perform a DSC to update one or more classifier rules to classify the one or more emergency call packets to be directed to a LLD service flow. The one or more classifier rules can be stored in a memory of the access point device 110, remote from the access point device 110, or both. In one or more embodiments, the cable modem 160 identifies the one or more emergency call packets as high priority traffic based on the one or more classifier rules and the one or more emergency call packets are routed based on this identification.

At step 408, the access point device 110 can disable a queue protection function of the cable modem 160. Disabling the queue protection function allows one or more associated voice packets (the one or more emergency call packets) to be routed via the LLD service flow instead of a normal classic service flow.

At step 410, the access point device 110 routes the one or more emergency call packets via the LLD service flow based on the one or more classifier rules. At step 412, the one or more emergency call packets are sent to a network device 180 via the LLD service flow, for example, via a CMTS 150. The network device is identified as a target of the emergency call, for example, based on the one or more identifiers.

At step 414, the access point device 110 receives one or more response emergency call packets via the LLD service flow. In this way, traffic (such as one or more data packets) associated with the emergency call are handled with high priority, low latency as the traffic is directed in both directions via a LLD service flow. By implementing the processes discussed herein, an emergency call can receive high priority low latency routing via a LLD service flow and any response associated with the emergency call can also be routed via the LLD service flow.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication or access network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. An access point device for routing one or more emergency call packets associated with an emergency call, the access point device comprising:
an embedded multimedia terminal adapter (eMTA);
a cable modem coupled to the eMTA;
a memory; and
a processor coupled to the memory, the processor configured to execute one or more computer-readable instructions stored on the memory to cause the access point device to:
receive at the eMTA the one or more emergency call packets associated with the emergency call;
send from the eMTA an emergency call notification to the cable modem;
perform, by the cable modem, a dynamic service change (DSC) to update one or more classifier rules to classify the one or more emergency call packets to be directed to a low latency data over cable service interface specification (LLD) service flow; and
route the one or more emergency call packets via the LLD service flow based on the one or more classifier rules.

2. The access point device of claim 1, wherein the one or more emergency call packets are sent using real-time protocol (RTP) via the LLD service flow.

3. The access point device of claim 1, wherein the processor is further configured to execute the one or more computer-readable instructions to further cause the access point device to:
disable a queue protection function.

4. The access point device of claim 1, wherein at least one of the one or more emergency call packets comprise one or more emergency call identifiers.

5. The access point device of claim 4, wherein the processor is further configured to execute the one or more computer-readable instructions to further cause the access point device to:
identify the one or more emergency call packets as associated with an emergency call based on the one or more emergency call identifiers; and
wherein routing the one or more emergency call packets is based on the identifying.

6. The access point device of claim 1, wherein the processor is further configured to execute the one or more computer-readable instructions to further cause the access point device to:
receive one or more response emergency call packets via the LLD service flow.

7. The access point device of claim 1, wherein the one or more classifier rules are stored in the memory.

8. A method by an access point device to route one or more emergency call packets associated with an emergency call, the method comprising:
receiving at an embedded multimedia terminal adapter (eMTA) of the access point device the one or more emergency call packets associated with the emergency call;
sending from the eMTA an emergency call notification to a cable modem of the access point device;
performing, by the cable modem, a dynamic service change (DSC) to update one or more classifier rules to classify the one or more emergency call packets to be directed to a low latency data over cable service interface specification (LLD) service flow; and
routing the one or more emergency call packets via the LLD service flow based on the one or more classifier rules.

9. The method of claim 8, wherein the one or more emergency call packets are sent using real-time protocol (RTP) via the LLD service flow.

10. The method of claim 8, further comprising disabling a queue protection function.

11. The method of claim 8, wherein at least one of the one or more emergency call packets comprise one or more emergency call identifiers.

12. The method of claim 11, further comprising:
identifying the one or more emergency call packets as associated with an emergency call based on the one or more emergency call identifiers; and
wherein routing the one or more emergency call packets is based on the identifying.

13. The method of claim 8, further comprising receiving one or more response emergency call packets via the LLD service flow.

14. The method of claim 8, wherein the one or more classifier rules are stored in the memory.

15. A non-transitory, computer-readable medium of an access point device storing one or more computer-readable instructions for routing one or more emergency call packets that when executed by a processor, cause the access point device to perform one or more operations comprising:
receiving at an embedded multimedia terminal adapter (eMTA) of the access point device the one or more emergency call packets associated with the emergency call;
sending from the eMTA an emergency call notification to a cable modem of the access point device;
performing, by the cable modem, a dynamic service change (DSC) to update one or more classifier rules to classify the one or more emergency call packets to be directed to a low latency data over cable service interface specification (LLD) service flow; and
routing the one or more emergency call packets via the LLD service flow based on the one or more classifier rules.

16. The non-transitory, computer-readable medium of claim 15, wherein the one or more emergency call packets are sent using real-time protocol (RTP) via the LLD service flow.

17. The non-transitory, computer-readable medium of claim 16, wherein the one or more computer-readable instructions when executed by the processor, further cause the processor to perform the one or more operations further comprising:
disabling a queue protection function.

18. The non-transitory, computer-readable media of claim 15, wherein the one or more computer-readable instructions when executed by the processor, further cause the processor to perform the one or more operations further comprising:
identifying the one or more emergency call packets as associated with an emergency call based on one or more emergency call identifiers of at least one of the one or more emergency call packets; and
wherein routing the one or more emergency call packets is based on the identification.

19. The non-transitory computer-readable media of claim 15, wherein the one or more computer-readable instructions when executed by the processor, further cause the processor to perform the one or more operations further comprising:
receive one or more response emergency call packets via the LLD service flow.

20. The non-transitory computer-readable media of claim 15, wherein the one or more classifier rules are stored in the memory.
